(19) United States
(12) Patent Application Publication
(10) Pub. No.: US 2017/0061959 A1
(43) Pub. Date: Mar. 2, 2017

(54) Systems and Methods For Detecting Keywords in Multi-Speaker Environments

(71) Applicant: Disney Enterprises, Inc., Burbank, CA (US)

(72) Inventors: Jill Fain Lehman, Pittsburgh, PA (US); Rita Singh, Pittsburgh, PA (US)

(73) Assignee: Disney Enterprises, Inc.

(21) Appl. No.: 14/842,528

(22) Filed: Sep. 1, 2015

(51) Int. Cl. G10L 15/08

(52) U.S. Cl. CPC G10L 15/08; G10L 2015/088

(57) ABSTRACT

There is provided a system for keyword recognition comprising a memory storing a keyword recognition application, a processor executing the keyword recognition application to receive a digitized speech from an analog-to-digital (A/D) converter, divide the digitized speech into a plurality of speech segments having a first speech segment, calculate a first probability of distribution of a first keyword in the first speech segment, determine that a first fraction of the first speech segment includes the first keyword, in response to comparing the first probability of distribution with a first threshold associated with the first keyword, calculate a second probability of distribution of a second keyword in the first speech segment, and determine that a second fraction of the first speech segment includes the second keyword, in response to comparing the second probability of distribution with a second threshold associated with the second keyword.

### BACKGROUND

As speech recognition technology has advanced, voice-activated devices have become more and more popular and have found new applications. Today, an increasing number of mobile phones, in-home devices, and automobile devices include speech or voice recognition capabilities. Although the speech recognition modules incorporated into such devices are trained to recognize specific keywords, they tend to be unreliable. This is because keywords may be spoken in noisy environments, by more than one person, at the same time as other keywords, or with all of these problems simultaneously. Unrecognized keywords can frustrate a speaker, and may cause the speaker to stop using voice commands and resort to manual controls.

### SUMMARY

The present disclosure is directed to systems and methods for detecting keywords in multi-speaker environments, substantially as shown in and/or described in connection with at least one of the figures, as set forth more completely in the claims.

### BRIEF DESCRIPTION OF THE DRAWINGS

FIG. 1 shows a diagram of an exemplary system for detecting keywords in multi-speaker environments, according to one implementation of the present disclosure;

FIG. 2 shows an exemplary input speech for processing by the system of FIG. 1, according to one implementation of the present disclosure;

FIG. 3 shows an exemplary speech segment for processing by the system of FIG. 1, according to one implementation of the present disclosure; and

FIG. 4 shows a flowchart illustrating of an exemplary method of detecting keywords in multi-speaker environments, according to one implementation of the present disclosure.

### DETAILED DESCRIPTION

The following description contains specific information pertaining to implementations in the present disclosure. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

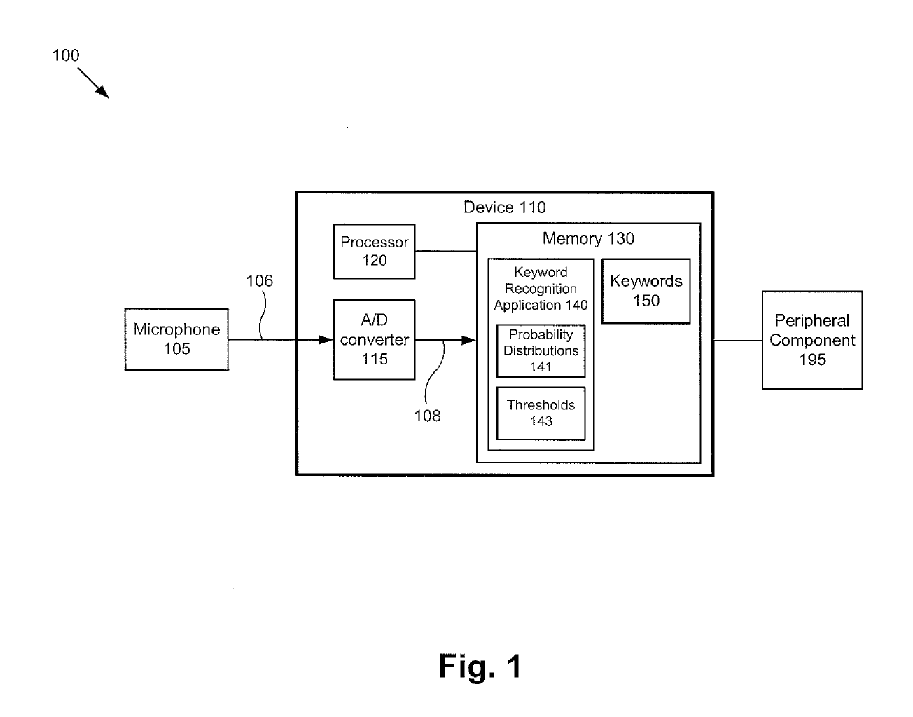

FIG. 1 shows a diagram of an exemplary system for detecting keywords in a multi-speaker environment, according to one implementation of the present disclosure. System 100 includes microphone 105, device 110, and peripheral component 195. Device 110 includes analog-to-digital (A/D) converter 115, processor 120, and memory 130. Processor 120 is a hardware processor, such as a central processing unit (CPU) used in computing devices. Memory 130 is a non-transitory storage device for storing computer code for execution by processor 120, and also storing various data and parameters. Memory 130 includes keyword recognition application 140 and keywords 150. In some implementations, memory 130 may be a remote memory (not shown), such as cloud storage, and keyword recognition application 140 and keywords 150 may be stored in the cloud. Keyword recognition application 140 and keywords 150 may be accessed over a computer network (not shown), such as the Internet.

Device 110 uses microphone 105 to receive speech or voice commands from a user or a plurality of users, such as a first user and a second user playing a speech controlled video game. A/D converter 115 is configured to receive input speech 106 from microphone 105, and convert input speech 106, which is in analog form, to digitized speech 108, which is in digital form. As shown in FIG. 1, A/D converter 115 is electronically connected to memory 130, such that A/D converter 115 can make digitized speech 108 available to speech recognition application 140 in memory 130. Using A/D converter 115, analog audio signals or input speech 106 may be converted into digital signals or digitized speech 108 to allow speech recognition application 140 to process digitized speech 108 for recognizing or detecting spoken keywords. Speech recognition is typically accomplished by pre-processing digitized speech 108, extracting features from the pre-processed digitized speech, and performing computation and scoring to match extracted features of the pre-processed digitized speech with keywords.

Keyword recognition application 140 is a computer algorithm for recognizing keywords in digitized speech 108. Keyword recognition application 140 includes probability distributions 141 for a plurality of keywords. Probability distributions 141 may include a plurality of probability distributions corresponding to a plurality of keywords. In some implementations, keyword recognition application 140 may learn the plurality of probability distributions corresponding to the plurality of keywords from a plurality of training instances of each keyword.

Keyword recognition module 140 also includes thresholds 143. Thresholds 143 may include a plurality of thresholds, where each threshold may correspond to a keyword of keywords 150. In some implementations, each threshold of thresholds 143 may be a fraction or a percentage, and may be used as a comparator for measuring a portion of a speech segment of digitized speech 108 that includes a keyword. In other implementations, each threshold of thresholds 143 may be a duration that may be used as a comparator for measuring the duration of a keyword in a speech segment of digitized speech 108. In some implementations, thresholds 143 may be based on the training instances of each keyword used to train probability distributions 141.

Keywords 150 include a plurality of keywords that keyword recognition application 140 may be able to recognize in digitized speech 108. In some implementations, keywords 150 may include two keywords, three keywords, or any number of keywords up to M keywords, M being an integer. In some implementations, each keyword of keywords 150 may have a corresponding action. For example, a keyword may be a command for a video game, so that the corresponding action is an action of a character in the video game, or the corresponding action may set a control in the video game or video game system.

Peripheral component 195 may be a functional component that is part of device 110 or peripheral component 195 may be functionally connected to device 110. Peripheral component 195 may be suitable for executing an action associated with a keyword of keywords 150. For example, peripheral component 195 may be a component for changing the station to which a smart car radio is tuned, changing a listening mode of a smart car radio, such as changing from radio to auxiliary mode. Peripheral component 195 may change a temperature setting of an in-home smart thermostat, change the mode of an in-home smart thermostat, such as from air conditioning to heat. Peripheral device 195 may include a heating element of a smart oven that is capable of being activated or deactivated when the oven is turned on or off.

In some implementations, peripheral component 195 may include a display suitable for displaying video content, such as a video game or an on-screen control menu of a video game console or video playback device. In some implementations, peripheral component 195 may be a television, a computer monitor, a display of a tablet computer, or a display of a mobile phone. Peripheral component 195 may be a light emitting diode (LED) display, an organic light emitting diode (OLED) display, a liquid crystal display (LCD), a plasma display, a cathode ray tube (CRT), an electroluminescent display (ELD), or other display appropriate for viewing video content and/or video games.

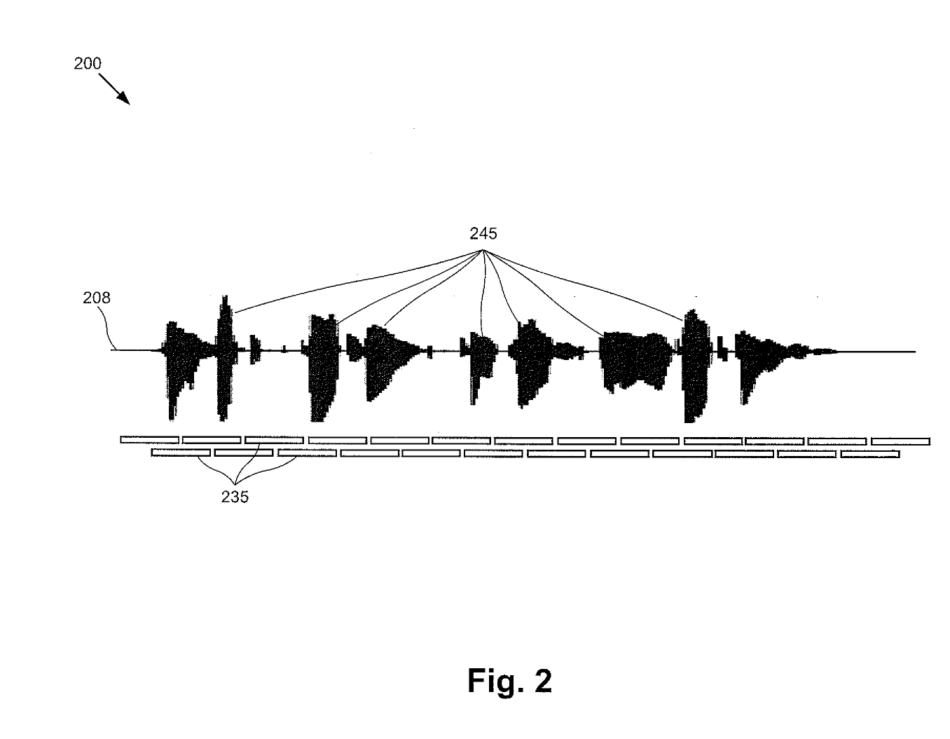

FIG. 2 shows an exemplary input speech for processing by system 100 of FIG. 1, according to one implementation of the present disclosure. Diagram 200 shows digitized speech 208 including a plurality of spoken words 245. In some implementations, digitized speech 208 may include a keyword from keywords 150, a plurality of keywords from keywords 150, or no keywords from keywords 150. Portions of digitized speech 208 that do not contain a keyword from keywords 150 may be classified as background, where background may include no spoken words, or may include unrecognizable spoken words, or may include spoken words that are not the keywords. Digitized speech 208 may be divided into a plurality of speech segments 235. In some implementations, speech segments 235 may overlap. In some implementations, keyword recognition application 140 may detect a keyword or a plurality of keywords in each segment 235 of digitized speech 208.

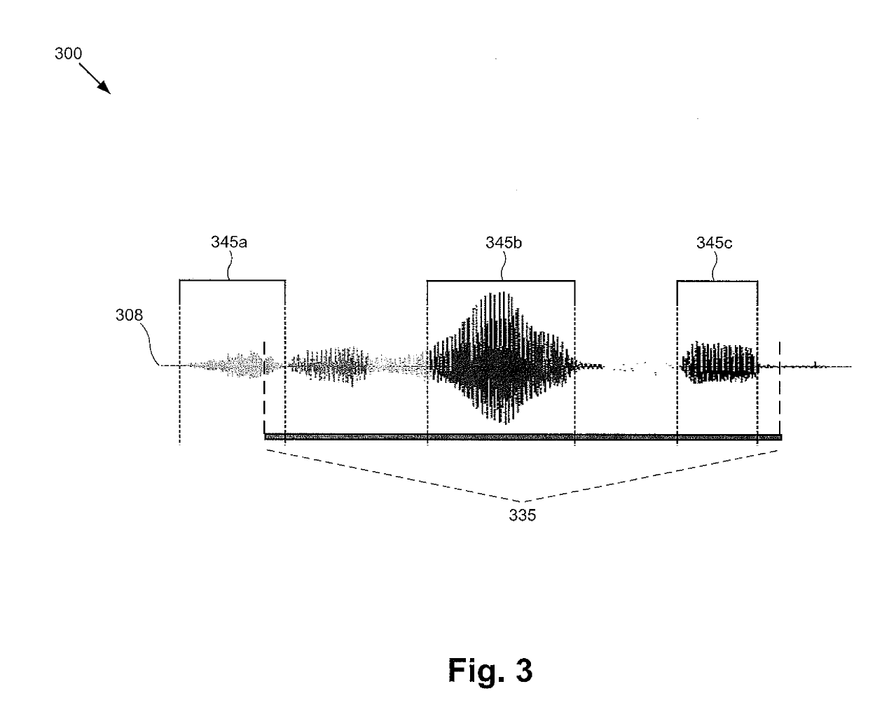

FIG. 3 shows an exemplary speech segment for processing by system 100 of FIG. 1, according to one implementation of the present disclosure. Diagram 300 shows digitized speech 308 including a plurality of spoken words 345a, 345b and 345c, and speech segment 335. Spoken word 345a may be a spoken word that is spoken by a player of a voice controlled video game before the beginning of speech segment 335, but ending within speech segment 335. Spoken word 345b may be a spoken word that is spoken within speech segment 335, and may be spoken louder than other words spoken during speech segment 335. Spoken word 345c may be a spoken word that is spoken within speech segment 335, but is spoken more quietly than spoken word 345b. In some implementations, the relative loudness of spoken words may refer to the strength of the signal received by microphone 105.

In situations where spoken words 345a-345c are three distinct keywords, speech recognition application 140 may detect each keyword in speech segment 335 if the fraction of speech segment 335 corresponding to each keyword is greater than the threshold for each keyword. Accordingly, speech recognition application 140 may detect no keywords, one keyword, two keywords, or three keywords in speech segment 335. In some implementations, not shown in FIG. 3, spoken words including keywords may overlap in digitized speech 308, such as when multiple children are playing a voice-controlled video game and speak over one another.

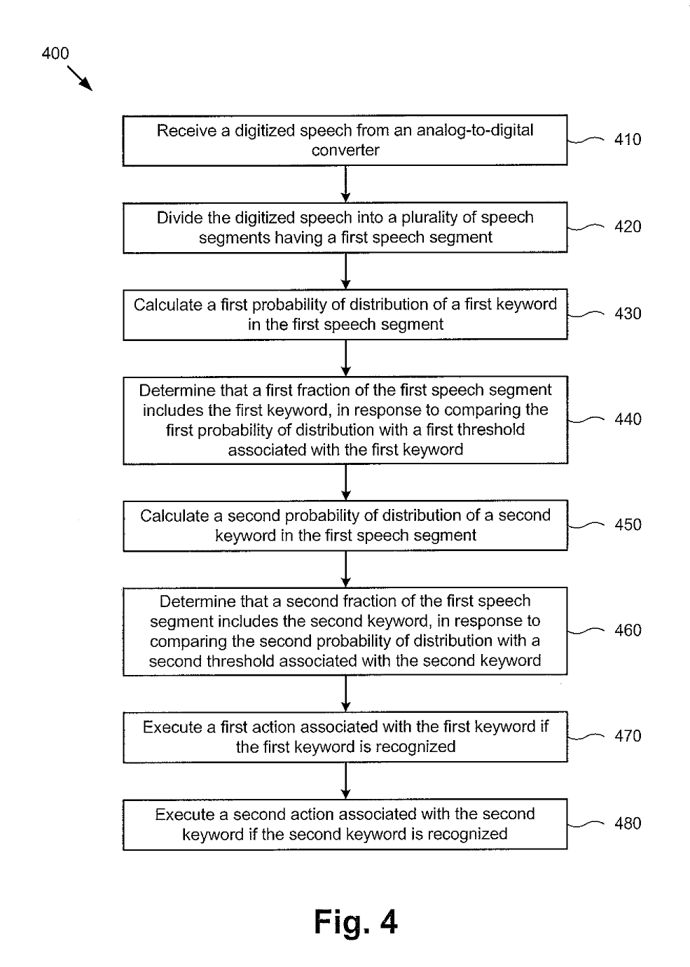

FIG. 4 shows a flowchart of an exemplary method of detecting keywords in a multi-speaker environment, according to one implementation of the present disclosure. At 410, speech recognition application 140 receives digitized speech 108 from A/D converter 115. Device 110 uses A/D converter 115 to convert input speech 106 from an analog form to a digital form, and generates digitized speech 108. To convert the signal from analog to digital form, the A/D converter samples the analog signal at regular intervals and sends digitized speech 108 to keyword recognition application 140. Method 400 continues at 420, where speech recognition application 140 divides digitized speech 108 into a plurality of speech segments including a first speech segment. In some implementations, the plurality of speech segments may be overlapping speech segments, and/or the speech segments may include sliding window segments. The length of each segment and the overlap between adjacent segments may be optimized empirically.

At 430, speech recognition application 140 calculates a first probability of distribution of a first keyword in the first speech segment. Since there may be M keywords, there may be 2^{M} classes, representing the 2^{M} possible combinations of the M possible keywords. Speech recognition application 140 may represent each keyword event by a class, where a keyword event is any combination of keywords. For instance, if there are only two possible keywords (e.g. “Go” and “Jump”), speech recognition application 140 will include 4 classes, representing the events C₁=“only Go was uttered”, C₂=“Only Jump was uttered”, C₃=“Go and Jump were uttered simultaneously” and C₄=“Neither word was uttered”. Speech recognition application 140 may learn the probability distribution P(X|Cᵢ) from training instances of data from each class. For example, speech recognition application 140 may learn P(X|C₃) from instances of recordings in which portions of a spoken “Go” and portions of a spoken “Jump” overlapped. These distributions may be mixture distributions, such as a mixture of distributions from the exponential family. The parameters of the distribution may be learned from the training data using any suitable algorithm.

In some implementations, keyword recognition application 140 may treat each speech segment of the plurality of segments such that the fraction a of any segment comprises the first keyword, and the remaining (1−α) comprises the background. Under this model, the probability distribution of the data within each speech segment of digitized speech 108 may be given by:

P(Xₜₑₛₜ)=αP(X|Word)+(1−α)P(X|Background) (1)

where α represents the fraction of the segment that is taken up by the word. α is unknown and must be determined. In some implementations, speech recognition application 140 may do so using the maximum-likelihood estimator:

α=argmax_{γ} log(γP(Xₜₑₛₜ|Word)+(1−γ)P(Xₜₑₛₜ|Background)) (2)

which determines α as a function of the value γ that results in a best “fit” of the overall distribution to the test data Xₜₑₛₜ.

In some implementations, different regions of the speech segment may be drawn from different classes, such as when multiple keywords occur in the speech segment. Accordingly, each fraction of the speech segment may be considered separately, such that some fractions may belong to one class (Word or Background) and the rest to the other. Speech recognition application may do so by assuming that every feature vector X in Xₜₑₛₜ (which represents a segment with many feature vectors) may be drawn independently. Correspondingly, the class-conditional distributions of vectors, P(X|Word) and P(X|Background), representing respectively the distributions of feature vectors from audio segments that only comprise the keyword and audio segments that include no part of the keyword, are known, having been estimated from some training data.

In order to generate Xₜₑₛₜ, each vector in Xₜₑₛₜ may be individually generated. To generate any individual vector, first the class may be selected, and subsequently the vector may be drawn from the class conditional distribution. α may be estimated to maximize log P(Xₜₑₛₜ):

$$α = arg {max}_{r} {\sum }_{X ∈ {X}_{test}} log ( γ P ( X \vert Word ) + ( 1 - γ ) P ( X \vert Background ) ) \qquad ( 3 )$$

Equation 3 may be optimized using any algorithm, such as simple gradient ascent, or expectation maximization (EM). The obtained a will represent the estimate of the fraction of the segment Xₜₑₛₜ that is dominated by the target word. The above equation is a maximum-likelihood estimator, so the overall method is a maximum-likelihood classification algorithm to detect keywords. The maximum-likelihood formulations P(X|Word) and P(X|Background) must capture the distributions of the data under the kind of conditions that are encountered in application scenarios (e.g., ambient noise inside a specific building, outside, etc.).

Conventionally, such distributions have been modeled as mixture distributions of the form:

$$P ( X \vert Class ) = {\sum }_{k} P ( k \vert Class ) P ( X \vert k , Class )$$

where k represents an index over mixture components, and P(X|k,Class) represents the individual component distributions of the mixture. The most common form for P(X|k,Class) in such applications has been a member of the exponential family of distributions, making P(X|Class) itself a mixture of exponential distributions. More generally, P(X|k,Class) may be any distribution that models the data well.

Speech recognition application 140 may specify the probability distribution of any vector X in a test segment as:

$$P ( X ) = {\sum }_{C} {α}_{C } P ( X \vert C )$$

where the variable C can take as values one of the 2^{M} values representing every combination of keywords. Generalizing across the possible classes, each α_{C} represents the fraction of the segment Xₜₑₛₜ that comprises feature vectors belonging to class C. For example, speech recognition application 140 may convert a speech segment to a feature vector sequence. In some implementations, speech recognition application 140 may model a plurality of keyword probability distributions from the feature vector sequence and a background probability distribution from the feature vector sequence, where each keyword probability distribution of the plurality of keyword probability distributions corresponds to a keyword of the plurality of keywords and background includes any portion of the speech segment that does not include a keyword. Speech recognition application 160 may learn all of the α_{C} values from Xₜₑₛₜ by maximizing log P(Xₜₑₛₜ).

$$\{ {α}_{{C}_{1}} , {α}_{{C}_{2}} , … , {α}_{{C}_{1}^{M}} \} = {arg max}_{\{ {α}_{{C}_{1}} , {α}_{{C}_{2}} , … , {α}_{{C}_{1}^{M}} \}} {\sum }_{X ∈ {X}_{test}} log {\sum }_{C} {\hat{α}}_{C} P ( X \vert C ) \qquad ( 4 )$$

Equation 4 may be optimized using any appropriate algorithm, such as gradient descent or EM.

Any single keyword may appear in multiple classes. In some implementations, speech recognition application 140 may model the first speech segment as a combination of a plurality of keyword vectors and a plurality of background vectors. For instance, in a two-word example including the keywords “Go” and “Jump,” “Go” features both in C₁ (Go only) and C₃ (Go and Jump spoken together). Thus, the total fraction of Xₜₑₛₜ that comprises “Go” must consider both classes, and will be given by α_{GO}=α_{C1}+α_{C3}. Speech recognition application 140 may model a speech segment probability distribution as a mixture of the plurality of keyword probability distributions and the background probability distribution. In some implementations, speech recognition application 140 may estimate a plurality of keyword mixture weights corresponding to the plurality of keyword probability distributions and a background mixture weight corresponding to the background probability distribution using any maximum-likelihood technique.

In some implementations, the first probability of distribution may be calculated by comparing the first speech segment with a probability distribution of the first keyword from probability distributions 141. Based on the probability distribution of the first keyword from probability distributions 141, keyword recognition application 140 may calculate a probability of the duration of the first keyword in the first speech segment. In some implementations, the duration of the first keyword compared to the duration of the first speech segment may be the first probability of distribution.

At 440, speech recognition application 140 determines that a first fraction of the first speech segment includes the first keyword, in response to comparing the first probability of distribution with a first threshold associated with the first keyword. In some implementations, the first fraction may be a ratio of the duration of the first keyword, according to the first probability of distribution, to the duration of the first speech segment. In other implementations, the first fraction may be a ratio of the portion of the first speech segment determined to be the first keyword to the portion of the first speech segment that is background, where background includes all sound including background noise and other words that do not represent the first keyword. In some implementations, background may include keywords other that the first keyword. Speech recognition application 140 may equate each keyword mixture weight of the plurality of keyword mixture weights to a corresponding plurality of probabilities of each keyword of the plurality of keywords and to a corresponding plurality of fractions of the first speech segment that contain each keyword of the plurality of keywords. In some implementations, speech recognition application 140 may determine a first keyword probability and the first fraction of the speech segment including the first keyword based on the first keyword mixture weight.

In some implementations, speech recognition application 140 may compare a with a first threshold of thresholds 143. If a exceeds the first threshold, speech recognition application 140 may determine that the speech segment includes the keyword corresponding to the first threshold. In general, once α_{Keyword} is computed for all keywords, any keyword for which the corresponding a value exceeds a threshold may be considered to have been detected in the segment. The first threshold may be calibrated to obtain different operating points—a high value of the first threshold will result in conservative, high-precision classification, where the probability ratio must pass a high threshold for the instance to be classified as the first keyword. A high threshold ensures that when an instance is identified as the first keyword, it is done so with high confidence, at the cost of occasionally missing instances of the first keyword because the likelihood ratio does not exceed the threshold. On the other hand, a low value of the first threshold will result in high-recall classification, where instances of the first keyword will rarely be missed, but in exchange for a larger fraction of data instances that are not the first keyword also being classified as being the first keyword.

At 450, speech recognition application 140 calculates a second probability of distribution of a second keyword in the first speech segment. Then, at 460, speech recognition application 140 determines that a second fraction of the first speech segment includes the second keyword, in response to comparing the second probability of distribution with a second threshold associated with the first keyword. The second threshold may be calibrated for high-precision results or high-recall results. In some implementations, speech recognition application 140 may determine a second keyword probability and the second fraction of the speech segment including the second keyword based on the second keyword mixture weight.

At 470, speech recognition application 140 executes a first action associated with the first keyword if the first keyword is recognized. In some implementations, the first keyword may be a command for a game, such as a voice-controlled video game. When speech recognition application 140 recognizes the first keyword, speech recognition application may execute the command. For example, the first keyword may be the command “Go,” which may be used to advance a player forward through a video game. When the first keyword “Go” is recognized, speech recognition module 140 may advance the player through the video game. In other implementations, system 100 may include a smart device, such as a smart car radio, a smart thermostat or a smart oven. Accordingly, execution of the first action may include turning on the smart device, turning off the smart device, changing a setting of the smart device, programming the smart device, etc. Likewise, the second keyword may have an associated action.

At 480, speech recognition application executes a second action associated with the second keyword if the second keyword is recognized. In some implementations, the second keyword may be a command for a game, such as a voice-controlled video game. When speech recognition application 140 recognizes the second keyword, speech recognition application may execute the command. For example, the second keyword may be the command “Jump,” which may be used for a player to avoid hazards or move over obstacles in a video game. When the second keyword “Jump” is recognized, speech recognition module 140 may have the player's character in the game jump. In other implementations, system 100 may include a smart device, and execution of the second action may include turning on the smart device, turning off the smart device, changing a setting of the smart device, programming the smart device, etc.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described above, but many rearrangements, modifications, and substitutions are possible without departing from the scope of the present disclosure.

What is claimed is:

1. A system for keyword recognition, the system comprising:
a microphone configured to receive an input speech;
an analog-to-digital (A/D) converter configured to convert the input speech from an analog form to a digital form and generate a digitized speech;
a memory storing a keyword recognition application;
a hardware processor executing the keyword recognition application to:
receive the digitized speech from the A/D converter;
divide the digitized speech into a plurality of speech segments having a first speech segment;
calculate a first probability of distribution of a first keyword in the first speech segment;
determine that a first fraction of the first speech segment includes the first keyword, in response to comparing the first probability of distribution with a first threshold associated with the first keyword;
calculate a second probability of distribution of a second keyword in the first speech segment; and
determine that a second fraction of the first speech segment includes the second keyword, in response to comparing the second probability of distribution with a second threshold associated with the second keyword.

2. The system of claim 1, wherein the first keyword at least partially overlaps the second keyword in the first speech segment.

3. The system of claim 1, wherein at least one of the first threshold and the second threshold is calibrated for high precision detection of the first keyword.

4. The system of claim 1, wherein at least one of the first threshold and the second threshold is calibrated for high recall detection of the first keyword.

5. The system of claim 1, wherein the plurality of speech segments include sliding window segments.

6. The system of claim 1, wherein, after determining the first speech segment includes the first keyword, the hardware processor is further configured to execute a first action associated with the first keyword.

7. The system of claim 1, wherein, after determining the first speech segment includes the second keyword, the hardware processor is further configured to execute a second action associated with the second keyword.

8. The system of claim 1, wherein at least one of the first keyword and the second keyword is a command for a game.

9. The system of claim 1, wherein the input speech includes speech from a first user and speech from a second user.

10. The system of claim 9, wherein the first user speaks the first keyword and the second user speaks the second keyword.

11. A method of keyword recognition, for use with a system having a microphone, an analog-to-digital (A/D) converter, a memory including a keyword recognition application, and a hardware processor, the method comprising:
receiving, using the hardware processor, a digitized speech from the A/D converter;
dividing, using the hardware processor, the digitized speech into a plurality of speech segments having a first speech segment;
calculating, using the hardware processor, a first probability of distribution of a first keyword in the first speech segment;
determining, using the hardware processor, that a first fraction of the first speech segment includes the first keyword, in response to comparing the first probability of distribution with a first threshold associated with the first keyword;
calculating, using the hardware processor, a second probability of distribution of a second keyword in the first speech segment; and
determining, using the hardware processor, that a second fraction of the first speech segment includes the second keyword, in response to comparing the second probability of distribution with a second threshold associated with the second keyword.

12. The method of claim 11, wherein the first keyword at least partially overlaps the second keyword in the first speech segment.

13. The method of claim 11, wherein the first threshold is calibrated for high precision detection of the first keyword.

14. The method of claim 11, wherein the first threshold is calibrated for high recall detection of the first keyword.

15. The method of claim 11, wherein the plurality of speech segments include sliding window segments.

16. The method of claim 11, further comprising:
executing, using the processor, a first action associated with the first keyword if the first keyword is recognized.

17. The method of claim 11, further comprising:
executing, using the processor, a second action associated with the second keyword if the second keyword is recognized.

18. The method of claim 11, wherein the at least one of the first keyword and the second keyword is a command for a game.

19. The method of claim 11, wherein the input speech includes speech from a first user and speech from a second user, and wherein the first user speaks the first keyword and the second user speaks the second keyword.

20. A system for keyword recognition, the system comprising:
a microphone configured to receive an input speech;
an analog-to-digital (A/D) converter configured to convert the input speech from an analog form to a digital form and generate a digitized speech;
a memory storing a keyword recognition application;
a hardware processor executing the keyword recognition application to:
receive the digitized speech from the A/D converter;
divide the digitized speech into a plurality of speech segments, including a first speech segment including a plurality of keywords and background, wherein background includes portions of the first speech segment that do not contain keywords;
convert the first speech segment to a feature vector sequence;
model a plurality of keyword probability distributions from the feature vector sequence, wherein each keyword probability distribution of the plurality of keyword probability distributions corresponds to a keyword of the plurality of keywords;
model a background probability distribution from the feature vector sequence;
model the first speech segment as a combination of a plurality of keyword vectors and a plurality of background vectors;
model a speech segment probability distribution as a mixture of the plurality of keyword probability distributions and the background probability distribution;
estimate a plurality of keyword mixture weights corresponding to the plurality of keyword probability distributions and a background mixture weight corresponding to the background probability distribution using an any maximum-likelihood technique;
equate each keyword mixture weight of the plurality of keyword mixture weights to a corresponding plurality of probabilities of each keyword of the plurality of keywords and to a corresponding plurality of fractions of the first speech segment that contain each keyword of the plurality of keywords.
